(19) United States
(12) Patent Application Publication
(10) Pub. No.: US 2026/0119146 A1
(43) Pub. Date: Apr. 30, 2026

(54) PEER VERIFICATION FOR ONBOARDING OF A DATA PROCESSING SYSTEM

(71) Applicant: Dell Products L.P., Round Rock, TX (US)

(72) Inventors: SUDHIR VITTAL SHETTY, Cedar Park, TX (US); JACOB R. HUTCHESON, Pflugerville, TX (US); CHRISTOPHER BAUER ATKINSON, Woodstock, GA (US)

(21) Appl. No.: 18/932,924

(22) Filed: Oct. 31, 2024

(51) Int. Cl. G06F 8/61

(52) U.S. Cl. CPC G06F 8/61

(57) ABSTRACT

Methods and systems for managing operation of data processing systems are disclosed. When a data processing system of the data processing systems is attempting to onboard to a deployment, the data processing system may obtain a peer verification request from an orchestrator that manages operation of the deployment. The data processing system may attempt to distribute network information indicated by the peer verification request to at least one of the other data processing systems deemed to be a trusted device by the orchestrator. By distributing the network information using a limited network distribution mechanism to the trusted device, the data processing system may be inferred to be properly positioned with respect to a network environment of the deployment. Operation of the data processing system may be updated based on communication from the orchestrator indicating whether the data processing system is deemed properly positioned to onboard to the deployment.

### FIELD

Embodiments disclosed herein relate generally to managing operation of data processing systems. More particularly, embodiments disclosed herein relate to managing onboarding of a data processing system of the data processing systems by verifying a network environment of the data processing system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show interaction diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments.

However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems. The data processing systems may provide computer-implemented services to any type and number of other devices and/or users of the data processing systems. The computer-implemented services may include any quantity and type of such services.

To provide at least a portion of the computer-implemented services, a data processing system of the data processing systems may be onboarded to a deployment. For example, to onboard the data processing system, the data processing system may, cooperatively with an orchestrator, update operation of the data processing system by performing a zero-touch provisioning process to obtain information and/or access to join the deployment.

Because the data processing system may be improperly positioned (e.g., positioned in an undesired network environment), the data processing system may negatively impact computer-implemented services provided by the deployment if onboarded to the deployment.

To reduce a likelihood that the data processing system may be allowed to join the deployment while improperly positioned, a network environment of the data processing system may be verified by an orchestrator that manages operation of the deployment. To verify the network environment of the data processing system, the orchestrator may provide a peer verification request. The peer verification request may indicate instructions for the data processing system to distribute a payload based on network information to at least one of the other data processing systems deemed to be a trusted device by the orchestrator.

Based on validation of the payload by the orchestrator, the data processing system may obtain communication to update operation of the data processing system to facilitate joining the deployment. Alternatively, the communication may indicate that the data processing system is not deemed properly positioned and therefore may not participate in the computer-implemented services provided by the deployment.

Thus, embodiments disclosed herein may provide an improved method for managing operation of data processing systems by using at least one trusted device in a deployment to verify a position of a data processing system of the data processing systems prior to allowing the data processing system to join the deployment. By doing so, a quality of computer-implemented services provided by the deployment of at least a portion of the data processing systems may be improved.

In an embodiment, a method for managing operations of data processing systems is provided. The method may include: during an attempted onboarding of a data processing system of the data processing systems to a deployment: prior to the data processing system being allowed to join the deployment: (i) obtaining, by the data processing system and from an orchestrator that manages operation of the deployment, a peer verification request, the peer verification request indicating: (a) network information to be collected by the data processing system, and (b) identification information for at least one of the other data processing systems that is deemed to be a trusted device for the attempted onboarding; (ii) attempting, by the data processing system, to distribute a payload based on the network information to at least one of the other data processing systems using: (a) the identification information, and (b) a limited network distribution mechanism; (iii) obtaining, by the data processing system, a communication from the orchestrator, the communication being based, at least in part, on the payload and/or a lack of obtaining the payload by the orchestrator; and (iv) updating, by the data processing system, operation based on the communication to facilitate provisioning of computer-implemented services by the deployment.

Updating the operation may include: in a first instance of the communication where the communication indicates that the data processing system is deemed to be properly positioned by the orchestrator: (i) cooperating, by the data processing system, with the orchestrator to update operation of the data processing system to be placed in a compliant state for joining the deployment; and (ii) after joining the deployment while in the compliant state, providing, by the data processing system, at least a portion of computer-implemented services provided by the deployment.

Updating the operation may include in a second instance of the communication where the communication indicates that the data processing system is deemed to not be properly positioned by the orchestrator: (i) performing, by the data processing system, at least one action to place the data processing system in a standby state so that the data processing system does not participate in and/or disrupt the computer-implemented services provided by the deployment.

The method may further include: after joining the deployment: (i) obtaining, by the data processing system, a second payload from a second data processing system of the data processing systems that has not joined the deployment; and (ii) forwarding, by the data processing system, the second payload to the orchestrator to facilitate ascertaining, by the orchestrator, whether the second data processing system is deemed to be properly positioned.

The limited network distribution mechanism may be a layer two network communication.

The limited network distribution mechanism may be a broadcast limited to a network segment on which the data processing system is positioned.

The identification information may include at least one selected from a group consisting of: (i) an identifier of the at least one other data processing system; and (ii) an identifier of a communication channel between the data processing system and the at least one other data processing system.

The identifier of the communication channel may be at least one identifier of a communication port of the data processing system.

Attempting to distribute the payload may include: attempting, by the data processing system, to send at least one encrypted copy of the network information to a network addressable endpoint associated with the at least one of the other data processing systems.

The network addressable endpoint may be limited based on the limited network distribution mechanism usable to communicate by the data processing system.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

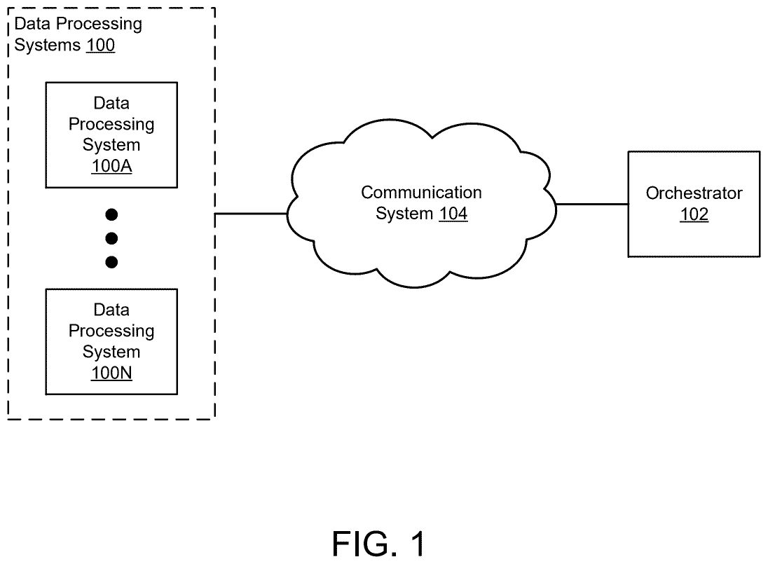

Turning to FIG. 1, a block diagram illustrating a system in accordance with an embodiment is shown. The system shown in FIG. 1 may provide for management of data processing systems that may provide, at least in part, computer-implemented services (e.g., to user of the system and/or devices operably connected to the system).

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, orchestrator 102, and/or any other type of devices (not shown in FIG. 1). Other types of computer-implemented services may be provided by the system shown in FIG. 1 without departing from embodiments disclosed herein.

To provide the computer-implemented services, any number of data processing systems of data processing systems 100 may be deployed to any number of deployments. The data processing systems of the deployments may cooperatively provide the computer-implemented services.

To join a deployment, a data processing system (e.g., 100A) of data processing systems 100 may be onboarded to the deployment. For example, data processing system 100A may attempt to onboard to the deployment by performing a zero-touch provisioning process to obtain information and/or access to join the deployment.

The deployment may be configured to operate in a certain network environment to provide at least a portion of the computer-implemented services. Data processing systems may be required to be positioned in a physical location that may correspond to and/or be compatible with joining the deployment in the certain network environment. For example, a group of data processing systems positioned in a data center may participate in computer-implemented services provided by a deployment configured to operate in a network environment of the data center.

However, a data processing system (e.g., 100A) may be improperly positioned (e.g., positioned in an undesired network environment) while attempting to onboard to the deployment. If allowed to onboard to the deployment while improperly positioned, data processing system 100A may negatively impact (e.g., disrupt) the computer-implemented services provided by the deployment and/or other data processing systems near the newly deployed system.

For example, consider a scenario in which data processing system 100A is attempting to onboard to a deployment operating in a data center. If data processing system 100A is positioned outside of a network environment of the data center (e.g., in a second data center, in an environment operated by a malicious entity, etc.) and is allowed to onboard to the deployment while improperly positioned, data processing system 100A may obtain access to sensitive data while being physically insecure, the deployment may be vulnerable to malicious attacks (e.g., the new data processing system may serve as an attack vector), and/or any other impacts to computer-implemented services provided by the data processing system and/or the deployment may occur.

In general, embodiments disclosed herein may provide methods, systems, and/or devices for managing data processing systems. To reduce a likelihood that a data processing system of the data processing systems may participate in providing computer-implemented services while improperly positioned, a network environment of the data processing system may be verified by an orchestrator that manages operation of the deployment.

To verify the network environment of the data processing system, orchestrator 102 may provide a peer verification request. The peer verification request may indicate instructions for the data processing system to distribute a payload based on network information to at least one of the other data processing systems deemed to be a trusted device by the orchestrator.

The trusted device may include a data processing system that previously demonstrated to orchestrator 102 that the trusted device is properly positioned in a corresponding deployment. For example, the trusted device may have completed a verification via a direct interaction by a user providing an authentication code, token, and/or any performing any other access approval action to attest to a proper positioning of the trusted device.

Orchestrator 102 may store identification information (e.g., network addressable endpoints) related to any number of trusted devices that have been attested for. Additionally, orchestrator 102 may obtain and/or store a network policy corresponding to a deployment that may include, for example, network information of a data processing system (e.g., internet protocol address, domain name system, communication protocols, etc.), criteria to demonstrate that a data processing system is properly positioned to join a deployment, and/or any other information defined by an owner of the deployment.

When a new device (e.g., data processing system 100A) attempts to onboard to a deployment that may include at least the trusted device, the new device may obtain a peer verification request from orchestrator 102 that may indicate network information to be collected by the new device, identification information for the at least one trusted device, and/or any other instructions for the new device to demonstrate that the new device is properly positioned to be onboarded to the deployment.

Once collected based on the peer verification request, a payload (e.g., an encrypted copy of the network information) may be attempted to be sent by the new device to the at least one trusted device. To do so, the new device may use a limited network distribution mechanism to communicate with the at least one trusted device. The limited network distribution mechanism may include, for example, a layer two network communication, a broadcast limited to a network segment on which the new device is positioned, and/or any other processes. Once received by the at least one trusted device, the payload may be redirected to orchestrator 102 for validation based on the network policy.

Based on validation of the payload by orchestrator 102, the new device may obtain communication to update operation of the new device to facilitate joining the deployment. For example, the new device may perform various operations (e.g., configuration operations, security operations, software installation operations, account provisioning operations, etc.) to place the new device in a compliant state for joining the deployment. The new device may subsequently participate in at least a portion of the computer-implemented services provided by the deployment.

Alternatively, the communication may indicate that the new device is not deemed properly positioned and therefore may not be onboarded to the deployment. The new device may subsequently perform at least one action to place the new device in a standby state so that the new device does not participate in and/or disrupt the computer-implemented services provided by the deployment.

To provide the above noted functionality, the system may include data processing systems 100, and orchestrator 102. Each of these components is discussed below.

Data processing systems 100 may include any number of data processing systems (e.g., 100A-100N) that may individually and/or cooperatively provide at least a portion of the computer-implemented services while deployed to any number and/or types of deployments. To do so, a data processing system (e.g., 100A) of data processing systems 100 may onboard to a deployment to obtain resources (e.g., configurations, software, data access, etc.) to participate in computer-implemented services provided by the deployment.

Prior to being allowed to onboard to the deployment, data processing system 100A may demonstrate to an orchestrator of the deployment that data processing system 100A is properly positioned in a network environment of the deployment. To do so, data processing system 100A may obtain a peer verification request from the orchestrator to distribute a payload based on network information collected by data processing system 100A to at least one other data processing system (e.g., 100B) that is deemed to be a trusted device by the orchestrator. By doing so, data processing system 100A may be corroborated by data processing system 100B to be properly positioned in a network environment of the deployment. Data processing system 100A may subsequently be allowed to onboard to the deployment and provide at least a portion of the computer-implemented services provided by the deployment.

Furthermore, after joining the deployment, data processing system 100A may be deemed to be a trusted device by orchestrator 102 and may subsequently attest for a third data processing system (e.g., data processing system 100C) that may be attempting to onboard to the deployment. To do so, data processing system 100A may, for example, obtain a second payload from data processing system 100C and forward the second payload to orchestrator 102 to facilitate ascertaining, by the orchestrator, whether data processing system 100C is deemed to be properly positioned.

As discussed above, orchestrator 102 may provide onboarding management services. To provide the onboarding management services, orchestrator 102 may obtain a network policy (e.g., from an owner of data processing systems 100) that may define, for example, attributes of a network environment that a data processing system is required to be positioned to join a deployment in the network environment. When a new device (e.g., data processing system 100A) attempts to onboard to the deployment, orchestrator 102 may identify at least one trusted device and provide a peer verification request to the new device for the new device to communicate a payload to orchestrator 102 via the at least one trusted device. Once the payload is obtained and/or validated by orchestrator 102, orchestrator 102 may provide communication to the new device that may indicate whether the new device is allowed to join the deployment. By doing so, computer-implemented services provided by the deployment may be less likely to be negatively impacted by a data processing system joining the deployment while improperly positioned.

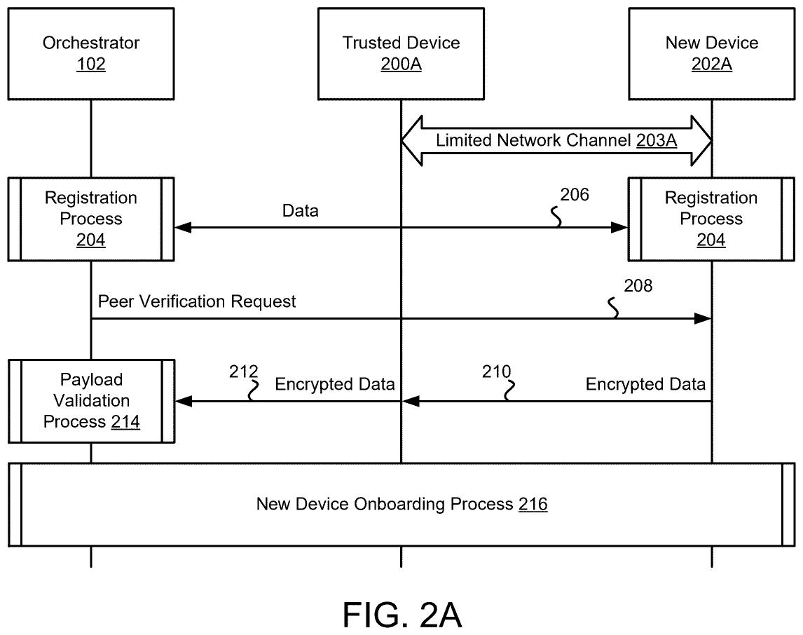

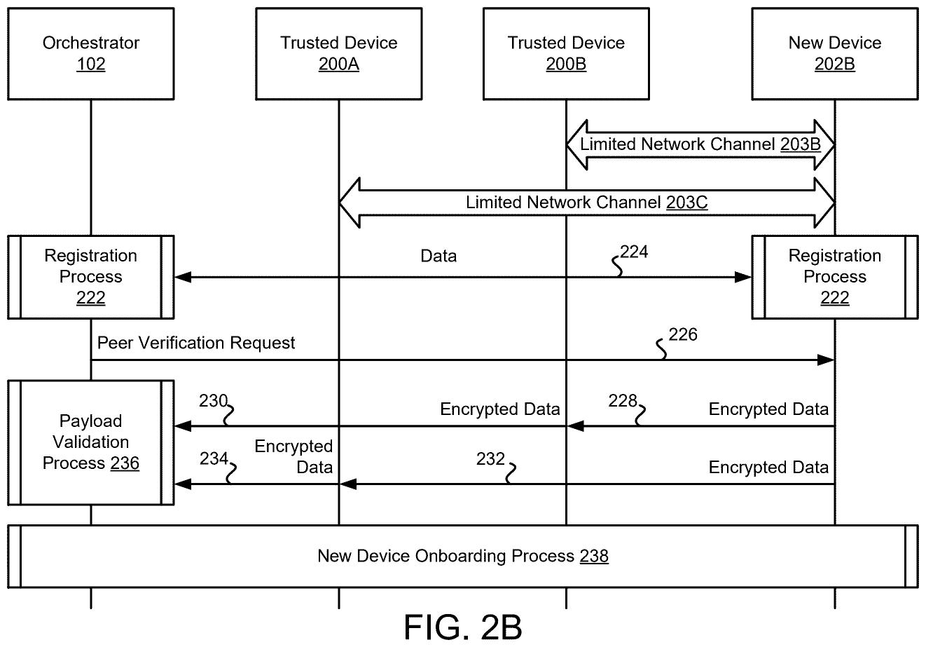

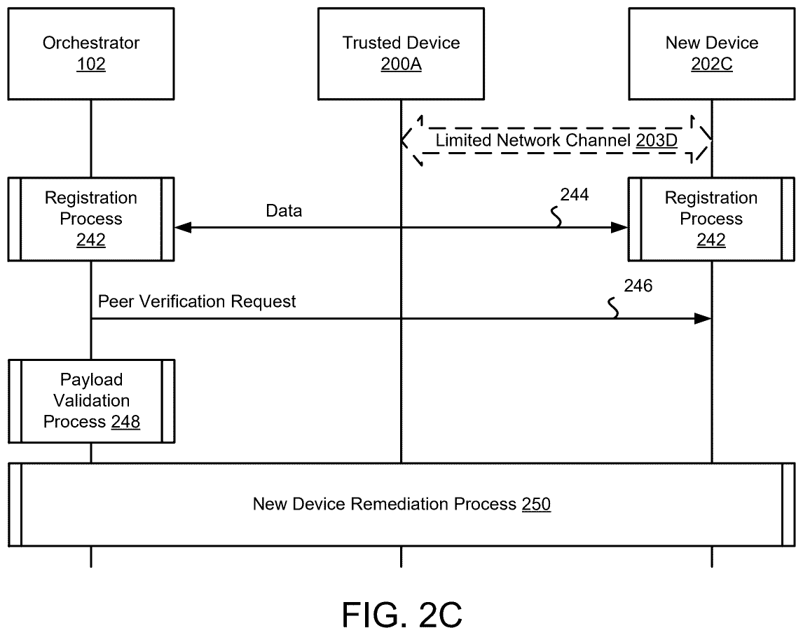

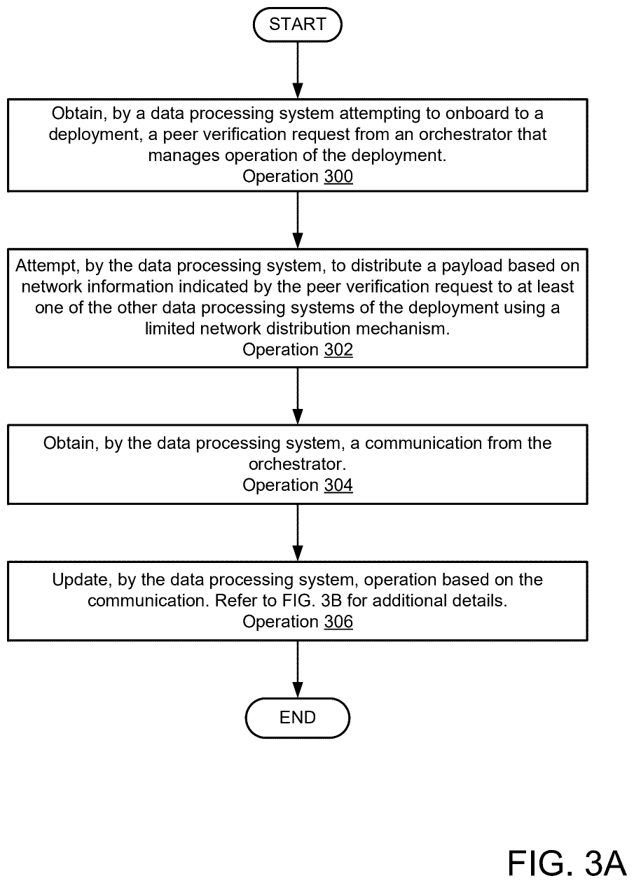

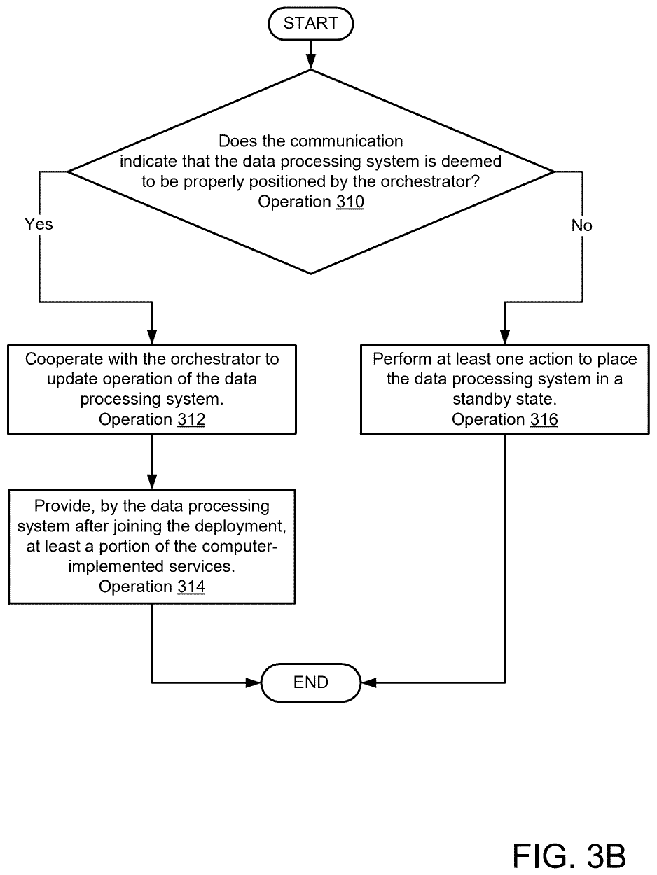

While providing their functionality, any of data processing systems 100 and/or orchestrator 102 may provide all or a portion of the methods shown in FIGS. 2A-3B.

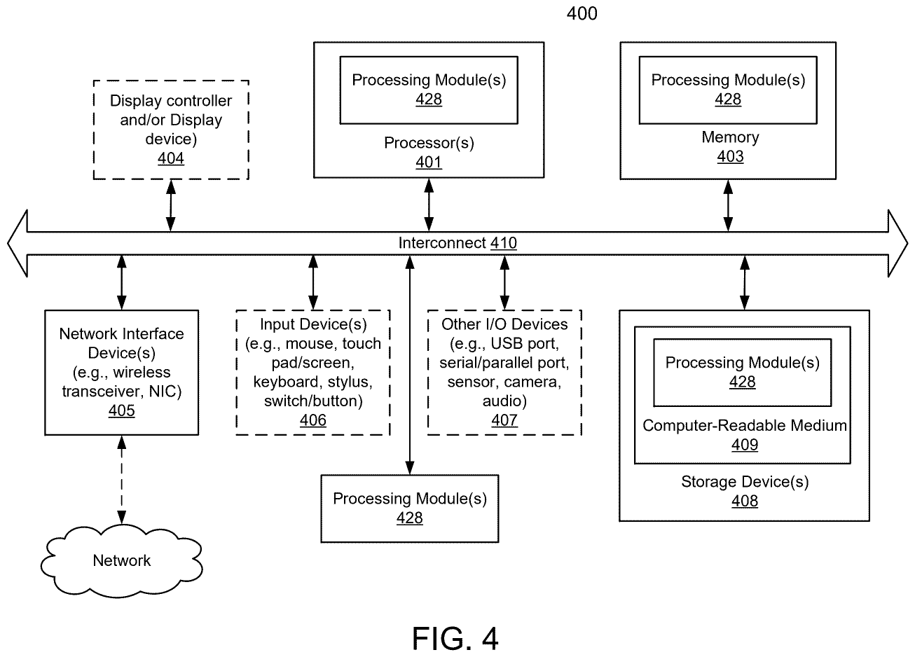

Communication system 104 may allow any of data processing systems 100, and orchestrator 102 to communicate with one another (and/or with other devices not illustrated in FIG. 1). To provide its functionality, communication system 104 may be implemented with one or more wired and/or wireless networks. Any of these networks may be a private network (e.g., the “Network” shown in FIG. 4), a public network, and/or may include the Internet. For example, data processing systems 100 may be operably connected to orchestrator 102 via the Internet. Data processing systems 100, orchestrator 102, and/or communication system 104 may be adapted to perform one or more protocols for communicating via communication system 104.

Any of (and/or components thereof) data processing systems 100, and orchestrator 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may manage a deployment of data processing systems by verifying a network environment of a data processing system of the data processing systems using peer verification prior to allowing the data processing system to be onboarded to the deployment. By doing so, a likelihood that computer-implemented services provided by the deployment may be negatively impacted by a data processing system onboarding to the deployment while improperly positioned may be reduced.

While illustrated in FIG. 1 with a limited number of specific components, a system may include additional, fewer, and/or different components without departing from embodiments disclosed herein.

To further clarify embodiments disclosed herein, interaction diagrams in accordance with an embodiment are shown in FIGS. 2A-2C. The interaction diagram may illustrate how data may be obtained and used within the system of FIG. 1.

In the interaction diagrams, processes performed by and interactions between components of a system in accordance with an embodiment are shown. In the diagrams, components of the system are illustrated using a first set of shapes (e.g., 102, 200, etc.), located towards the top of each figure. Lines descend from these shapes. Processes performed by the components of the system are illustrated using a second set of shapes (e.g., 204, 214, etc.) superimposed over these lines. Interactions (e.g., communication, data transmissions, etc.) between the components of the system are illustrated using a third set of shapes (e.g., 206, 208, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 206 may occur prior to the interaction labeled as 208. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during an attempted onboarding of a new device to a deployment.

Trusted device 200A may include a first data processing system of data processing systems 100 that may previously have been deemed to be properly positioned by orchestrator 102 and subsequently onboarded to the deployment. For example, to have been deemed to be properly positioned, trusted device 200A may have completed a challenge issued by orchestrator 102 when attempting to onboard. The challenge may include, for example, a direct interaction with a user of trusted device 200A with the user inputting a code/token negotiated with orchestrator 102, validation via a completion of a previous iteration of a peer verification request, and/or any other processes.

New device 202A may include a second data processing system of data processing systems 100 that is attempting to onboard to the deployment. For example, new device 202A may be shipped to a location of an entity (e.g., a user, owner, etc.) tasked with onboarding and/or providing computer-implemented services using at least a portion of data processing systems 100. To attempt to onboard new device 202A to the deployment, new device 202A may be required to be properly positioned in a network environment configured for the deployment.

Limited communication channel 203A is shown to indicate a communication channel with which new device 202A may communicate with trusted device 200A. For example, consider a scenario in which new device 202A and trusted device 200A are positioned in a network segment. Prior to being onboarded (e.g., obtaining access to routing services for communication to a wide area network), new device 202A may use a limited network distribution mechanism for communication with trusted device 200A, for example, by broadcasting a communication to a subnet, directing the communication using a layer two network communication protocol (e.g., ethernet, address resolution, etc.), and/or any other processes.

To attempt to onboard the new device to the deployment, registration process 204 may be performed. During registration process 204, device onboarding may be initiated, and a verification process may be identified. For example, to initiate the device onboarding, (i) new device 202 may be powered on, (ii) network information may be assigned to new device 202A via a network protocol (e.g., dynamic host configuration protocol), (iii) communication may be initiated between new device 202A and orchestrator 102, (iv) hardware components of new device 202A may be validated (e.g., cooperatively with orchestrator 102 using a certificate that may authenticate hardware component identities and/or configurations of new device 202A), and/or any other processes may be performed.

Once identified that new device 202A is attempting to onboard to the deployment, orchestrator 102 may identify the verification process for qualifying new device 202A to join the deployment with respect to a network environment of new device 202A. For example, to identify the verification process, orchestrator 102 may: (i) obtain a network policy defined by an owner of the deployment, (ii) identify a number and/or types of data processing systems deployed to the deployment, and/or perform any other actions.

At interaction 206, data may be exchanged between new device 202A and orchestrator 102. The data may include, for example, information related to new device 202A, second information usable to validate hardware components of new device 202A, requests from orchestrator 102 for a portion of the data, security data (e.g., keys) usable to secure data during transmission, and/or any other information while registration process 204 is performed.

At interaction 208, a peer verification request may be provided to new device 202A by orchestrator 102. To generate and provide the peer verification request to new device 202A, orchestrator 102 may (i) identify trusted device 200A based at least on a network environment of the deployment that new device 202 is attempting to join, (ii) obtain identification information for trusted device 200A, (iii) indicate network information to be collected by new device 202A, (iv) transmit the peer verification request via a message to new device 202A, and/or any other processes.

At interaction 210, encrypted data may be provided to trusted device 200A by new device 202A. To generate and provide the encrypted data to trusted device 200A, new device 202A may (i) collect network information (e.g., internet protocol address, subnet mask, etc.) based on the peer verification request, (ii) encrypt the network information using security data maintained by orchestrator 102, (iii) transmit a message that may include the encrypted data across limited distribution channel 203A, and/or perform any other actions.

At interaction 212, the encrypted data may be provided to orchestrator 102 by trusted device 200A. The encrypted data may be provided to orchestrator 102 by (i) forwarding the encrypted data to orchestrator 102, (ii) storing the encrypted data in a storage for subsequent retrieval by orchestrator 102, and/or any other processes. By providing the encrypted data to orchestrator 102, orchestrator 102 may validate the encrypted data from new device 202A that may be corroborated by trusted device 200A.

To validate the encrypted data, payload validation process 214 may be performed. During payload validation process 214, the encrypted data from new device 202A may be validated based on the network policy for the deployment. For example, to validate the encrypted data, orchestrator 102 may (i) confirm the reception of the encrypted data, (ii) decrypt the encrypted data using the security data to obtain the network information, (iii) compare the network information to acceptance criteria defined by the network policy (e.g., thresholds for variations in network addresses), and/or perform any other actions. By validating the encrypted data from new device 202A, orchestrator 102 may allow new device 202A to onboard to the deployment.

To onboard new device 202A to the deployment, new device onboarding process 216 may be performed. During new device onboarding process 216, operation of new device 202A may be updated to facilitate joining the deployment. For example to update operation of new device 202A, (i) access to resources may be provided to new device 202A by orchestrator 102, (ii) software may be installed on new device 202A, (iii) security settings may be configured on new device 202A, (iv) a role may be assigned to new device 202A, (v) identification information for new device 202A may be added to a list of trusted devices, and/or any other processes may be performed to place new device 202A in a compliant state for joining the deployment.

Thus, processes and interactions shown in FIG. 2A, a data processing system may be onboarded to a deployment by communicating network information to an orchestrator of the deployment via a trusted device and based on a peer verification request. By doing so, a likelihood of a negative impact to computer-implemented services provided by the deployment as a result of an improperly positioned data processing system joining the deployment may be reduced.

Turning to FIG. 2B, a second interaction diagram in accordance with an embodiment is shown. The second interaction diagram may illustrate processes and interactions that may occur during an attempted onboarding of a new device to a deployment that may require corroboration by a plurality of trusted devices.

Trusted device 200A and trusted device 200B may include a first data processing system and a second data processing system of data processing systems 100 that may previously have been deemed to be properly positioned by orchestrator 102 and subsequently onboarded to the deployment. Trusted device 200B may also include, for example, the data processing system (e.g., new device 202A from FIG. 2A) that previously was deemed to be properly positioned and joined the deployment. After joining the deployment, a network addressable endpoint of trusted device 200B may have been added to a repository of trusted devices maintained by orchestrator 102.

New device 202A may include a third data processing system of data processing systems 100 that is attempting to onboard to the deployment.

Limited communication channel 203B and limited communication channel 203C are shown to indicate a first and second communication channel with which new device 202A may communicate with trusted device 200B and trusted device 200A, respectively. Limited communication channel 203B and limited communication channel 203C may allow for communication by using identification information for trusted device 200A and trusted device 200B.

Similar to registration process 204 and data exchanged during interaction 206, registration process 222 may be performed to attempt to onboard new device 202B to the deployment and data may be exchanged between new device 202B and orchestrator 102 at interaction 226 while registration process 222 is performed. The deployment may include trusted device 200A, trusted device 200B, and/or any number of other data processing systems of data processing systems 100.

At interaction 226, a peer verification request may be provided to new device 202B by orchestrator 102. To generate and provide the peer verification request to new device 202B, orchestrator 102 may (i) identify both trusted device 200A and trusted device 200B based on a network environment of the deployment that new device 202 is attempting to join, (ii) obtain identification information for trusted device 200A and trusted device 200B, (iii) indicate network information to be collected by new device 202B, (iv) transmit the peer verification request via a message to new device 202B, and/or any other processes.

At interaction 228, encrypted data may be provided to trusted device 200B by new device 202B. To generate and provide the encrypted data to trusted device 200B, new device 202B may (i) collect network information (e.g., internet protocol address, subnet mask, etc.) based on the peer verification request, (ii) encrypt the network information using security data maintained by orchestrator 102, (iii) transmit a message that may include the encrypted data across limited distribution channel 220, and/or perform any other actions.

At interaction 230, the encrypted data may be provided to orchestrator 102 by trusted device 200B. The encrypted data may be provided to orchestrator 102 by (i) forwarding the encrypted data to orchestrator 102, (ii) storing the encrypted data in a storage for subsequent retrieval by orchestrator 102, and/or any other processes.

Similar to interaction 228 and interaction 230, encrypted data may be provided to trusted device 200A by new device 202B at interaction 232 using limited network channel 221 and the encrypted data may be forwarded to orchestrator 102 by trusted device 200A. By providing the encrypted data to orchestrator 102, orchestrator 102 may validate the encrypted data from new device 202B that may be corroborated by both trusted device 200A and trusted device 200B.

To validate the encrypted data, payload validation process 236 may be performed. During payload validation process 214, the encrypted data from new device 202A may be validated based on the network policy for the deployment. For example, to validate the encrypted data, orchestrator 102 may (i) confirm the reception of the encrypted data from both trusted device 200A and trusted device 200B, (ii) decrypt the encrypted data using the security data to obtain the network information, (iii) compare the network information to acceptance criteria defined by the network policy (e.g., thresholds for variations in network addresses), and/or perform any other actions. If, for example, orchestrator 102 did not obtain a forwarded payload from either trusted device 200A and/or trusted device 200B based on the peer verification request provided, orchestrator 102 may determine that new device 202B is not properly positioned to join the deployment. By validating the encrypted data from new device 202A, orchestrator 102 may allow new device 202A to onboard to the deployment.

To onboard new device 202B to the deployment, new device onboarding process 238 may be performed similarly to new device onboarding process 216. During new device onboarding process 216, operation of new device 202A may be updated to place new device 202A in a compliant state for joining the deployment.

Thus, using processes and interactions shown in FIG. 2B, a data processing system attempting to be onboarded to a deployment may be deemed to be properly positioned for joining the deployment by distributing a payload to all trusted devices indicated by a peer verification request. By doing so, a network environment of the data processing system may be corroborated by the trusted devices while operating in the deployment.

Turning to FIG. 2C, a third interaction diagram in accordance with an embodiment is shown. The third interaction diagram may illustrate processes and interactions that may occur during an attempted onboarding of a new device to a deployment while the new device is improperly positioned.

New device 202C may include a fourth data processing system of data processing systems 100 that may be attempting to onboard a deployment. In FIG. 2C, new device 202C may be positioned in a second network environment not compatible with a network environment configured for the deployment. For example, new device 202C may be operated by an entity in a second data center when the deployment is configured to operate in a first data center.

Limited network channel 203D is shown in long-dashed lines to indicate that new device 202C may obtain network identification information for communication with trusted device 200A from orchestrator 102, however, because new device 202C may be improperly positioned with respect to trusted device 200A and/or other data processing systems of the deployment, communication between new device 202C and trusted device 200A may not occur while new device 202C is attempting to onboard to the deployment.

Similar to registration process 204 and data exchanged during interaction 206, registration process 242 may be performed to attempt to onboard new device 202C to the deployment and data may be exchanged between new device 202C and orchestrator 102 at interaction 244 while registration process 222 is performed. Based on the data provided by new device 202C at interaction 244, hardware components of new device 202C may be validated during registration process 242. For example, new device 202C may be validated to be a data processing system that may include components and/or configurations that may potentially be compatible with a deployment managed by orchestrator 102.

At interaction 246, a peer verification request may be provided to new device 202C by orchestrator 102. To generate and provide the peer verification request to new device 202C, orchestrator 102 may (i) identify trusted device 200A based at least on a network environment of the deployment that new device 202C is attempting to join, (ii) obtain identification information for trusted device 200A, (iii) indicate network information to be collected by new device 202C, (iv) transmit the peer verification request via a message to new device 202C, and/or any other processes. By providing the peer verification request to new device 202C, orchestrator 102 may obtain a response and/or a lack of a response usable to identify whether new device 202C is properly positioned.

To identify whether new device 202C is properly positioned, payload validation process 248 may be performed. During payload validation process 214, reception of a payload indicated by the peer verification request may be processed. For example, to process the reception of the payload, orchestrator 102 may (i) wait for communication from trusted device 200A over a certain period of time, (ii) query trusted device 200A for a status of communication from new device 202C, and/or perform any other actions. When a lack of obtaining the payload indicated by the peer verification request is processed by orchestrator 102, orchestrator 102 may deem new device 202C to be not properly positioned to be onboarded and subsequently perform at least one action to prevent new device 202C from joining the deployment.

To perform the at least one action to prevent new device 202C from joining the deployment, new device remediation process 250 may be performed. During new device remediation process 250, operation of new device 202C may be updated. For example, operation of new device 202C may be updated by: (i) issuing a command for new device 202C to be placed in a standby state, (ii) placing new device 202C in a limited operating state, (iii) decommissioning at least a portion of hardware components hosted by new device 202C, and/or performing any other actions.

Thus, using processes and interactions shown in FIG. 2B, a data processing system attempting to be onboarded to a deployment while improperly positioned may be prevented from joining the deployment. By doing so, a likelihood that the data processing system may disrupt computer-implemented services provided by the deployment may be reduced.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIGS. 3A-3B illustrate a methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing data processing systems for onboarding to a deployment in accordance with an embodiment is shown. The method may be performed, for example, by any of the components of the system of FIG. 1, and/or other components not shown therein.

Prior to operation 300, a data processing system of the data processing systems may attempt to onboard to a deployment of any number of other data processing systems that may provide computer-implemented services. For example, the data processing system may (i) perform a provisioning process that may indicate a request to join the deployment, (ii) initiate communication with an orchestrator that manages operation of the deployment, (iii) provide information related to hardware and/or software components of the data processing system, and/or perform any other actions.

At operation 300, a peer verification request may be obtained by the data processing system and from the orchestrator. The peer verification request may be obtained by: (i) receiving a message from the orchestrator indicating network information to be collected by the data processing system and/or identification information for at least one of the other data processing systems that is deemed to be a trusted device, (ii) participating in a publish-subscribe system where the data processing system subscribes to updates from the orchestrator, and/or any other processes.

At operation 302, a payload based on the network information may be attempted to be distributed by the data processing system to the at least one of the other data processing systems. The payload may be attempted to be distributed by: (i) issuing commands to collect the network information (e.g., from storage hosted by the data processing system, configuration files, network interfaces, etc.), (ii) encrypting the network information in the payload using security data (e.g., security keys that may be usable by the orchestrator to decrypt the payload), (iii) broadcasting the payload to a network segment indicated by the peer verification request, (iv) transmitting the payload to a network addressable endpoint (e.g., media access control address) of the at least one other data processing system, and/or any other processes.

At operation 304, the communication from the orchestrator may be obtained based at least in part, on the payload and/or lack of obtaining the payload by the orchestrator. The communication may be obtained by: (i) analyzing, by the orchestrator, the payload to generate the communication, (ii) receiving, by the data processing system, a message from the orchestrator indicating whether the data processing system is deemed properly positioned, (iii) participating in a publish-subscribe system where the data processing system subscribes to updates from the orchestrator, and/or any other processes.

At operation 306, operation of the data processing system may be updated based on the communication. Operation of the data processing system may be updated by: (i) cooperating with the orchestrator to place the data processing system in a compliant state for joining the deployment, (ii) providing computer-implemented services after joining the deployment, (iii) performing at least one action to place the data processing system in a standby state so that the data processing system does not participate in computer-implemented services provided by the deployment, and/or performing any other actions. Refer to FIG. 3B for additional details regarding updating operation of the data processing system based on the communication.

The method may end following operation 306.

Using the method shown in FIG. 3A, a position of a data processing system attempting to join a deployment operating in network environment may be verified based at least on a result of communication between the data processing system and a trusted device of the deployment using a limited network distribution mechanism.

Turning to FIG. 3B, a flow diagram illustrating a method updating operation of a data processing system for participating in a deployment in accordance with an embodiment is shown. The method may be performed, for example, by any of the components of the system of FIG. 1, and/or other components not shown therein.

At operation 310, a determination may be made regarding whether communication from the orchestrator indicates that the data processing system is deemed to be properly positioned. The determination may be made by (i) reading a response of the communication regarding a result of the request for the data processing system to onboard to the deployment, (ii) interpreting the communication using an application hosted by the data processing system, and/or any other processes. If the communication indicates the data processing system is deemed properly positioned (e.g., the determination is “Yes” at operation 310), then the method may proceed to operation 312. If the communication indicates the data processing system deemed to be not be properly positioned (e.g., the determination is “No” at operation 310), then the method may proceed to operation 316.

At operation 312, the orchestrator may be cooperated with to update operation of the data processing system. The orchestrator may be cooperated with by: (i) following instructions provided by the orchestrator, (ii) obtaining access to resources provided by the orchestrator, (iii) installing desired software indicated by the orchestrator, (iv) accepting a role assigned to the data processing system by the orchestrator, and/or performing any other actions to place the data processing system in a compliant state.

At operation 314, at least a portion of computer-implemented services provided by the deployment may be provided by the data processing system. The at least a portion of computer-implemented services may be provided by: (i) participating in operation of the deployment after onboarding to the deployment, (ii) providing compute resources desired by a user of the data processing system, and/or performing any other actions.

The method may end following operation 314.

Returning to operation 310, the method may proceed to operation 316 following operation 310 when communication from the orchestrator indicates the data processing system deemed to be not be properly positioned for onboarding to the deployment.

At operation 316, at least one action may be performed to place the data processing system in a standby state so that the data processing system does not participate in computer-implemented services provided by the deployment. The at least one action may be performed by: (i) invoking a command for the data processing system to be placed in the standby state, (ii) limiting operation of the data processing system, (iii) decommissioning at least a portion of hardware components hosted by the data processing system, and/or any other processes.

The method may end following operation 316.

Using the method shown in FIG. 3B, operation of the data processing system may be updated based on communication from an orchestrator that indicates whether the data processing system is deemed to be properly positioned for onboarding to a deployment. By doing so, the data processing system may either participate in computer-implemented services provided by the deployment or be prevented from disrupting the computer-implemented services provided by the deployment.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of data processing systems, the method comprising:
during an attempted onboarding of a data processing system of the data processing systems to a deployment:
prior to the data processing system being allowed to join the deployment:
obtaining, by the data processing system and from an orchestrator that manages operation of the deployment, a peer verification request, the peer verification request indicating:
network information to be collected by the data processing system, and
identification information for at least one of the other data processing systems that is deemed to be a trusted device for the attempted onboarding;
attempting, by the data processing system, to distribute a payload based on the network information to at least one of the other data processing systems using:
the identification information, and
a limited network distribution mechanism;
obtaining, by the data processing system, a communication from the orchestrator, the communication being based, at least in part, on the payload and/or a lack of obtaining the payload by the orchestrator; and
updating, by the data processing system, operation based on the communication to facilitate provisioning of computer-implemented services by the deployment.

2. The method of claim 1, wherein updating the operation comprises:
in a first instance of the communication where the communication indicates that the data processing system is deemed to be properly positioned by the orchestrator:
cooperating, by the data processing system, with the orchestrator to update operation of the data processing system to be placed in a compliant state for joining the deployment; and
after joining the deployment while in the compliant state, providing, by the data processing system, at least a portion of computer-implemented services provided by the deployment.

3. The method of claim 2, wherein updating the operation comprises:
in a second instance of the communication where the communication indicates that the data processing system is deemed to not be properly positioned by the orchestrator:
performing, by the data processing system, at least one action to place the data processing system in a standby state so that the data processing system does not participate in and/or disrupt the computer-implemented services provided by the deployment.

4. The method of claim 2, further comprising:
after joining the deployment:
obtaining, by the data processing system, a second payload from a second data processing system of the data processing systems that has not joined the deployment; and
forwarding, by the data processing system, the second payload to the orchestrator to facilitate ascertaining, by the orchestrator, whether the second data processing system is deemed to be properly positioned.

5. The method of claim 1, wherein the limited network distribution mechanism a layer two network communication.

6. The method of claim 1, wherein the limited network distribution mechanism is a broadcast limited to a network segment on which the data processing system is positioned.

7. The method of claim 1, wherein the identification information comprises at least one selected from a group consisting of:
an identifier of the at least one of the other data processing systems; and
an identifier of a communication channel between the data processing system and the at least one of the other data processing systems.

8. The method of claim 7, wherein the identifier of the communication channel is at least one identifier of a communication port of the data processing system.

9. The method of claim 1, wherein attempting to distribute the payload comprises:
attempting, by the data processing system, to send at least one encrypted copy of the network information to a network addressable endpoint associated with the at least one of the other data processing systems.

10. The method of claim 9, wherein the network addressable endpoint is limited based on the limited network distribution mechanism usable to communicate by the data processing system.

11. A non-transitory machine-readable medium having instructions stored therein, which when executed by a processor, cause the processor to perform operations for managing operation of data processing systems, the operations comprising:
during an attempted onboarding of a data processing system of the data processing systems to a deployment:
prior to the data processing system being allowed to join the deployment:
obtaining, by the data processing system and from an orchestrator that manages operation of the deployment, a peer verification request, the peer verification request indicating:
network information to be collected by the data processing system, and
identification information for at least one of the other data processing systems that is deemed to be a trusted device for the attempted onboarding;
attempting, by the data processing system, to distribute a payload based on the network information to at least one of the other data processing systems using:
the identification information, and
a limited network distribution mechanism;
obtaining, by the data processing system, a communication from the orchestrator, the communication being based, at least in part, on the payload and/or a lack of obtaining the payload by the orchestrator; and
updating, by the data processing system, operation based on the communication to facilitate provisioning of computer-implemented services by the deployment.

12. The non-transitory machine-readable medium of claim 11, wherein updating the operation comprises:
in a first instance of the communication where the communication indicates that the data processing system is deemed to be properly positioned by the orchestrator:
cooperating, by the data processing system, with the orchestrator to update operation of the data processing system to be placed in a compliant state for joining the deployment; and
after joining the deployment while in the compliant state, providing, by the data processing system, at least a portion of computer-implemented services provided by the deployment.

13. The non-transitory machine-readable medium of claim 12, wherein updating the operation comprises:
in a second instance of the communication where the communication indicates that the data processing system is deemed to not be properly positioned by the orchestrator:
performing, by the data processing system, at least one action to place the data processing system in a standby state so that the data processing system does not participate in and/or disrupt the computer-implemented services provided by the deployment.

14. The non-transitory machine-readable medium of claim 12, wherein the operations further comprise:
after joining the deployment:
obtaining, by the data processing system, a second payload from a second data processing system of the data processing systems that has not joined the deployment; and
forwarding, by the data processing system, the second payload to the orchestrator to facilitate ascertaining, by the orchestrator, whether the second data processing system is deemed to be properly positioned.

15. The non-transitory machine-readable medium of claim 11, wherein the limited network distribution mechanism a layer two network communication.

16. A data processing system, comprising:
a processor; and
a memory coupled to the processor to store instructions, which when executed by the processor, cause the processor to perform operations for managing operation of data processing systems, the operations comprising:
during an attempted onboarding of a data processing system of the data processing systems to a deployment:
prior to the data processing system being allowed to join the deployment obtaining, by the data processing system and from an orchestrator that manages operation of the deployment, a peer verification request, the peer verification request indicating:
network information to be collected by the data processing system, and
identification information for at least one of the other data processing systems that is deemed to be a trusted device for the attempted onboarding;
attempting, by the data processing system, to distribute a payload based on the network information to at least one of the other data processing systems using:
the identification information, and
a limited network distribution mechanism;
obtaining, by the data processing system, a communication from the orchestrator, the communication being based, at least in part, on the payload and/or a lack of obtaining the payload by the orchestrator; and
updating, by the data processing system, operation based on the communication to facilitate provisioning of computer-implemented services by the deployment.

17. The data processing system of claim 16, wherein updating the operation comprises:
in a first instance of the communication where the communication indicates that the data processing system is deemed to be properly positioned by the orchestrator:
cooperating, by the data processing system, with the orchestrator to update operation of the data processing system to be placed in a compliant state for joining the deployment; and
after joining the deployment while in the compliant state, providing, by the data processing system, at least a portion of computer-implemented services provided by the deployment.

18. The data processing system of claim 17, wherein updating the operation comprises:
in a second instance of the communication where the communication indicates that the data processing system is deemed to not be properly positioned by the orchestrator:
performing, by the data processing system, at least one action to place the data processing system in a standby state so that the data processing system does not participate in and/or disrupt the computer-implemented services provided by the deployment.

19. The data processing system of claim 17, wherein the operations further comprise:
after joining the deployment:
obtaining, by the data processing system, a second payload from a second data processing system of the data processing systems that has not joined the deployment; and
forwarding, by the data processing system, the second payload to the orchestrator to facilitate ascertaining, by the orchestrator, whether the second data processing system is deemed to be properly positioned.

20. The data processing system of claim 16, wherein the limited network distribution mechanism a layer two network communication.
